(19) United States
(12) Patent Application Publication
(10) Pub. No.: US 2008/0072392 A1
(43) Pub. Date: Mar. 27, 2008

(54) Double-sided windshield wiper

(76) Inventor: Barbara Livingston Capoano, Farmingdale, NJ (US)

Correspondence Address: Charles I. Brodsky, 2 Bucks Lane, Marlboro, NJ, 07746, US

(21) Appl. No.: 11/902,674

(22) Filed: Sep. 25, 2007

Related U.S. Application Data
(60) Provisional application No. 60/846,849, filed on Sep. 25, 2006.

(51) Int. Cl. B60S 1/04

(52) U.S. Cl. 15/250.01; 15/250.41

(57) ABSTRACT

A windshield wiper assembly positioned to clean the inside surface of an automotive vehicle windshield operative in conjunction with or separately from a second windshield wiper assembly positioned to clear the outside surface of the vehicle windshield.

### CROSS-REFERENCE TO RELATED APPLICATIONS

A Provisional Patent Application covering the invention described herein was filed Sep. 25, 2006, and assigned Ser. No. 60/846,849.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to automotive windshield wipers, in general, and to those operating with pivoted arms to swing back and forth over front and rear windshield glass.

2. Description of the Related Art

As is known and understood, a windshield wiper is a device used to wipe rain and dirt from a windshield—typically provided on automobiles, trucks, buses, locomotives, aircraft and ships. Generally consisting of an arm pivoted at one end with a long rubber blade attached to the other, the wiper operates to swing the blade back and forth over the glass, pushing water from its surface. Operated electrically, the wipers faithfully keep the window clear, moving the blade back and forth across the windshield countless times at an adjustable speed to sweep the water away—oftentimes with several continuous speeds and frequently with one or more intermittent settings.

As is also known and understood, the wipers may be powered in a variety of manners, and generally operate by combining two mechanical technologies—one, a combination electric motor and worm gear reduction to provide power to the wipers; and another, to convert the rotational output of the motor into the back-and forth motion of the wipers. The worm gear reduction used on the output of the electric motor serves to multiply the torque of the motor by about 50 times, while slowing the output speed of the motor that amount as well. Its output operates a linkage that moves the wipers back and forth—usually a short cam attached to the output shaft of the gear reduction. With the cam spinning around as the motor turns, its connection to a long rod moves the rod back and forth, such that its connection to a shorter rod then actuates the wiper blade on the driver's side. Another long rod is included to transmit the force from the driver's side to the passenger-side wiper blade.

Different wiper blade schemes may be employed. In the “tandem system”, one of the blades pivots from a point close to the driver's side of the vehicle, and the other blade pivots from near the middle of the windshield. A second scheme—referred to as the “single arm, controlled system”—utilizes a single wiper arm that extends and retracts as it sweeps across the windshield. Other designs use wiper blades that are mounted on opposite sides of the windshield and move in opposite directions (“opposed system”), and some employ a single wiper mounted in the middle (“single arm system”). These arrangements offer different degrees of coverage for the driver and/or exhibit different degrees of complication.

As is further known and understood, the wiper blades operate as squeegees, in which the arms of the wiper drag a thin rubber strip across the windshield to clear away the water. As will be appreciated, when the blade is new, its rubber is clean and possesses no nicks or cracks. Wiping the water away without leaving streaks, however, suffers over time as the blades age, nick or crack, and/or, as road grime builds up on its edge so that it does not make as tight a seal against the windshield. Streaks then result—and if wiping the edge with a cloth soaked in window cleaner until no more dirt comes off the blade, or if even pressure cannot be ensured over the length of the rubber blade—the wiper blade is best then replaced.

As will additionally be understood, many automobiles have rear-window wipers as well as those legally required for the front windshield. Inclusion of these rear-window designs have been more recently employed on hatchbacks, station wagons and sport utility vehicles—typically of the “single arm system” variety. They, too, suffer the same infirmities.

### SUMMARY OF THE INVENTION

The present invention recognizes that the inside surface of the windshield often develops a film from dust or from one's smoking in the vehicle—and that that limits a driver's vision even when the windshield wipers are operating optimally well. As the driver usually does not carry a bottle of glass cleaner in the vehicle to wipe down that inside windshield surface, and because car washers devote little effort to avoid streaking of the inside surface when attempting to clean the cab compartment, the driver's visibility through the windshield suffers when driving at night—and also on nice days when the sun shines from ahead. In accordance with the invention, on the other hand, an inside windshield wiper is provided to keep the inside surface clean as well and preventing glare.

### BRIEF DESCRIPTION OF THE DRAWINGS

These and other features of the present invention will be more clearly understood from a consideration of the following description, taken in connection with the single Figure of the drawing, helpful in an understanding of the double-sided windshield wiper of the invention.

### DETAILED DESCRIPTION OF THE INVENTION

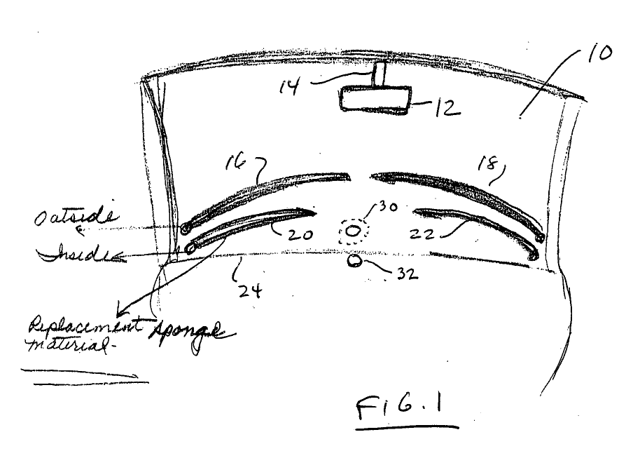

FIG. 1 illustrates a view of the front windshield 10 of an automotive vehicle as viewed from its cab compartment defined by its front and rear windshields. A rear view mirror is shown at 12 along with its mount 14—and, for example, with an “opposed system” wiper design of hinged blades 16, 18. In accordance with the teachings of the prior art, the wiper blades 16, 18 are hinged at a point outside the vehicle, and rest adjacent on the outside surface of the windshield—and conventionally employ rubber strips to clear away the water which collects. In accordance with the invention, on the other hand, a second pair of hinged blades 20, 22 is provided at a point inside the vehicle, to rest adjacent on the inside surface of the windshield 10, internal of the cab compartment. As will be evident, the inside blades 20, 22, would be shorter in length than the outside blades 16, 18 so as to fall short of the rear view mirror 12 in their operation, while continuing to clear the vision area of the windshield 10. As will be further understood, the inside wiper blades 20, 22 rest at the far depth of the dashboard 24, whether the outside wiper blades are of the “opposed system” design or of the other designs noted above. Also, the hinged blades 20, 22 may be of the same angle and shape as the hinged blades 16, 18 of FIG. 1, although shorter so as not to hit the rear view mirror 12—but of sufficient length to continue to clean the vision area of the driver.

Understanding that substantially only film and dust will collect on the inside surface of the windshield 10, the internal wiper blades 20, 22 are of a construction other than merely rubber, as are the outside wiper blades 16, 18. In particular, the inside blades 20, 22 are of a micro-sponge material preferably impregnated with a cleansing chemical to clean the inside windshield surface when operating. While able to be replaced should the impregnated chemical dry, utilization of a micro-sponge construction even, by itself, without supplemental impregnation, would reduce any such film and dust build-up.

As will be understood, the control stick for operating the internal wiper blades 20, 22 could be positioned on the dashboard, either joined with the same control for the external wiper blades 16, 18, or as a separate control; that way, they could be operated together or independently. Likewise, hinged internal blades (either singly or as a pair) could be incorporated at the inside surface of the rear windshield to keep that clean in similar manner. Analysis has shown that either or both of these added internal wiper configurations not only serves to clean the film built up on their respective inside surfaces, but serves to improve windshield defrosting of both the front and rear windshield configurations.

As will be appreciated by those skilled in the art, any need for replacement of the inside surface wiper blades would be required less frequently than that of the outside blades as they would not have to be operating as often—and, certainly, in not as many wipings since the inside surfaces are not continually being hit with repetitive rain or sleet.

Reference numeral 30 in the drawing typifies an outlet on the vehicle adjacent to and outside the front windshield to direct a stream of windshield washer fluid on its outside surface to be spread across such surface by the outside blades 16, 18 of the windshield. Reference numeral 32 represents a similar outlet adjacent the inside surface of the windshield to direct a spray mist of the windshield washer fluid on its inside surface to assist in cleaning, via the action of the inside wipers 20, 22, any film from dust or otherwise that may happen to lessen visibility looking through the windshield from the cab compartment. In a preferred construction, the outlet 32 is selected to provided a misting type spray to the inside surface of the windshield, while the outlet 30 provides more of a heavier cleaning fluid spray.

As will be appreciated by those skilled in the art, the spray controls for both the outside and inside windshield surfaces could be controlled from a common stalk within the cab compartment, or can be actuated by separately provided controls. In such way, the outlets 30, 32 could be operated together or independently. As will similarly be appreciated, like arrangements of windshield wiper assemblies can be utilized for the rear windshield of the vehicle defining the back of the driver cab compartment. One such assembly would be on the outside of the windshield, and one on the inside, operated individually or together by a second stick control in the cab compartment. Again, an outlet outside the rear windshield would be operated to direct a stream of windshield wiper fluid against the rear windshield, while an outlet inside the vehicle would direct a misting spray of the fluid against the inside surface of the rear windshield.

While there have been described what are considered to be preferred embodiments of the present invention, it will be readily appreciated by those skilled in the art that modifications can be made without departing from the scope of the teachings herein. For example, while the drawing illustrates a pair of front windshield wipers being used, the teachings of the invention apply equally as well to a design where only one such wiper blade is employed—as in driving a train or boat, for example. For at least such reason, therefore, resort should be had to the claims appended hereto for a true understanding of the scope of the invention.

I claim:

1. In a vehicle having a driver compartment, the combination comprising:
a front windshield defining a front of said compartment having an outside surface and an inside surface;
a first windshield wiper assembly having at least one wiper blade actuable to clear water from off said outside surface of said windshield;
a second windshield wiper assembly having a pair of wiper blades actuable to clean film, dust and water from off said inside surface of said windshield;
with said first windshield wiper assembly being hinged at a point outside said vehicle and adjacent said outside surface of said windshield;
and with said second windshield wiper assembly being hinged at a point inside said vehicle adjacent said inside surface of said windshield.

2. The combination of claim 1 wherein said second windshield wiper assembly includes at least one wiper blade composed of a micro-sponge material.

3. The combination of claim 2 wherein said second windshield wiper assembly includes at least one wiper blade composed of a micro-sponge material impregnated with a cleansing chemical.

4. The combination of claim 2 wherein said first windshield wiper assembly includes at least one wiper blade employing a rubber strip to clear water from off said outside surface of said windshield.

5. The combination of claim 1 wherein said first windshield wiper assembly includes a pair of wiper blades employing rubber strips to clear water from off said outer surface of said windshield and wherein said second windshield wiper assembly includes a pair of wiper blades composed of a micro-sponge material.

6. The combination of claim 5 wherein each of said pair of wiper blades of said second windshield wiper assembly is impregnated with a cleansing chemical.

7. The combination of claim 6 wherein a first of said first windshield wiper assembly blade pair is of the same angle and shape as a first of said second windshield wiper assembly blade pair, and wherein a second of said first windshield wiper assembly blade pair is of the same angle and shape as a second of said second windshield wiper assembly blade pair.

8. The combination of claim 7 wherein each of said second windshield wiper assembly blade pair is of a shorter length then each of said first windshield wiper assembly blade pair.

9. The combination of claim 1, including means within said driver compartment for diverting a stream of windshield washer fluid against the outside surface of said windshield.

10. The combination of claim 1, including means within said driver compartment for directing a spray mist of windshield washer fluid against the inside surface of said windshield.

11. The combination of claim 1, including first means within said driver compartment for directing a stream of windshield washer fluid against the outside surface of said windshield, and including second means within said driver compartment for directing a spray mist of windshield washer fluid against the inside surface of said windshield.

12. The combination of claim 11 wherein each of said first and second means is individually controllable from within said driver compartment.

13. The combination of claim 1, also including a rear windshield defining a rear of said compartment having an outside surface and an inside surface, a third windshield wiper assembly having at least one wiper blade actuable to clear water from off said outside surface of said rear windshield, a fourth windshield wiper assembly having a pair of wiper blades actuable to clear film, dust and water from off said inside surface of said rear windshield, with said third windshield wiper assembly being hinged outside said vehicle and adjacent said outside surface of said rear windshield, and with said fourth windshield wiper assembly being hinged inside said vehicle at a point adjacent said inside surface of said rear windshield.

14. The combination of claim 13 wherein said third windshield wiper assembly includes a pair of wiper blades employing rubber strips to clear water from off said outside surface of said rear windshield and wherein said fourth windshield wiper assembly includes a pair of wiper blades composed of a micro-sponge material.

15. The combination of claim 14 wherein each of said pair of wiper blades of said fourth windshield wiper assembly is impregnated with a cleansing chemical.
